(19) United States
(12) Patent Application Publication
(10) Pub. No.: US 2024/0336486 A1
(43) Pub. Date: Oct. 10, 2024

(54) ANODE MATERIAL

(71) Applicant: SGL CARBON SE, Wiesbaden (DE)

(72) Inventors: Ivano GALBIATI, Meitingen (DE); Alberto BIANCOLI, Meitingen (DE); Andreas KLEIN, Meitingen (DE); Daniel SZLACHETA, Novy Sacz (PL)

(73) Assignee: SGL CARBON SE, Wiesbaden (DE)

(21) Appl. No.: 18/294,670

(22) PCT Filed: Aug. 4, 2022
(86) PCT No.: PCT/EP2022/071992

§ 371 Date: Feb. 2, 2024

(30) Foreign Application Priority Data
Aug. 4, 2021 (DE) 102021120322.8

(51) Int. Cl. C01B 32/205; H01M 10/0525

(52) U.S. Cl. CPC C01B 32/205; H01M 10/0525; C01P 2004/03; C01P 2004/32; C01P 2004/61; C01P 2006/11; C01P 2006/40

(57) ABSTRACT

An anode material, an electrode comprising the anode material, a battery including the electrode a method of manufacturing the anode material and the use of the anode material.

### FIELD

The present disclosure relates to an anode material, an electrode comprising the anode material, a battery comprising the electrode a method of manufacturing the anode material and the use of the anode material.

### BACKGROUND

Lithium-ion batteries are rechargeable energy storage systems (secondary batteries) that have the highest energy density of the chemical and electrochemical energy storage systems, currently up to 250 Wh/kg, for example. The lithium-ion batteries are mainly used in the field of portable electronic devices, such as for laptops, computers or mobile phones, and in the field of means of transport, such as for bicycles or automobiles with electric drives.

For electromobility, higher energy densities of lithium-ion batteries are necessary to increase the range of vehicles, for portable electronic devices to extend the service life with one battery charge.

The current lithium-ion batteries cannot meet the fast rate of charge requirement to achieve an acceptable charging time of for example an electric vehicle. One of the limiting factors of the performance during fast charge is recognized to be the low wettability between electrode and electrolyte during the production of the cell. With increasing of the density of the electrode required to maximize the energy target of energy density and power density needed in automotive the wettability between the electrode and electrolyte is further decreased. Compared with the material used for the cathode graphite anode materials are particularly affected from the wettability decrease with the increasing of the electrode packaging manly because of the mechanical deformation caused from the electrode pressing process.

### SUMMARY

The object of the present disclosure is therefore to provide an anode material, the method of production and the use which overcomes or at least mitigates the above disadvantages of the prior art.

The present inventors have investigated how compaction of the graphite particulates influences the wettability and have surprisingly found that the wetting density can be suitably adjusted by adequately selecting well-known physical parameters such as tap density (also called tapped density) and particle size distribution. The tapped density is a well-known parameter in the art and describes an increased bulk density attained after mechanically tapping a container containing the powder sample. This finding allows the provision of n anode material for a lithium ion battery comprising carbon particles, wherein the anode material can be compressed onto a metal sheet to form a dense and fast wetting anode material layer, which anode material layer has a density ρ (in g/cm³) and a wetting time tw (in s) which is described by the following formula (I)

$${t}_{w} = {x}_{1} \times ( ρ - 1 , 0 ) + {x}_{2} \times {e}^{( {x}_{3} \times ( ρ - 1 , 7 ) )} \qquad ( I )$$

wherein
ρ is the density of the anode material compressed onto a metal sheet and
x₁ is between 50 and 158; x₂ is between 3 and 150 x₃ is between 13 and 45.

This means that the coefficients x₁, x₂ and x₃ must have the following units:
x₁ [s cm³/g]
x₂ [s]
x₃ [s cm³/g]

The above formula describes wettability (more specifically the speed of wetting) in relation to the density of the compressed anode material. Preferably, the density ρ (in g/cm³) of anode material compressed onto a metal sheet is between about 1.35 and 1.9, more specifically 1.4 to 1.85, more specifically 1.45 to 1.8, and in particular 1.5 to 1.75. The wetting time tw (in s) ranges from about 50 to about 600 seconds for these densities and is determined using standardized conditions and electrolyte solutions as described further below.

The anode material is compressed by calendering onto a metal sheet to achieve the target density. The measurement of the wettability is described below. The wettability of the anode material is important for the overall quality of the battery. During the production process of the battery the electrode material is wet by an electrolyte. If the wetting time of the electrode material is very high the electrode material is very inhomogeneous and the machine time and, thus, production time is undesirably high.

In some embodiments, the carbon particles comprise graphite.

In some embodiments, the sum of total functional groups of the anode material is less or equal to 10 μmol/g, preferably between 5.5 μmol/g-0.05 μmol/g, more preferably between 1 μmol/g-0.05 μmol/g.

The sum of total of functional groups is defined as algebraical sum of all acidic and alkali chemical functions attached on the material surface. The sum of total of functional groups is less or equal to 10 μmol/g, because above 10 μmol/g the side reactions increases, and the interface is reduced. If you have more side reactions than the reversible capacity of the battery is reduced because of the formation of a larger amount of solid electrolyte interface.

In some embodiments, the anode material has a distribution with 50% of the volume of the distribution with a circularity (s₅₀) of 0.85-1.0, preferably 0.85 to 0.90. Below 0.85 the tap density of the material decreases. A too low tap density it is in general not desirable because it limits the maximal electrode density that can be achieved by compression. Furthermore, the interface is reduced and therefore not wanted side reactions increases.

In some embodiments, the anode material has a distribution with 99% of the volume of distribution with a circularity (s₉₉) of 0.95 to 1.

In some embodiments, the anode material is in powder form, i.e. a particulate material.

In some embodiments, the anode material has a ratio of tap density of tap 1500/tap 30 of 1.0-2.2, preferably of 1.0-1.8, more preferably of 1.2 to 1.6. If the tap density ratio is below 1.0 the packaging of the electrode material is not optimal which reduces the properties of the electrode. Poor packaging leads to a low tap density and has a negative effect on the densification of the electrode layer.

Measures for selecting and/or preparing graphites having the desired wettability are not particularly limited. It will be appreciated that, relying on the present disclosure, graphite parameters which are influencing void space formation may be investigated to identify further working embodiments. For instance, the skilled person could investigate particle size (distribution) and tapping density. Measures for selecting/preparing graphites having a suitable particle size distribution are well-known in the art and not particularly limited. For instance, the particles can be milled under conditions which result in smaller or bigger graphite particles and broader or narrower particle size distributions. It is also possible to classify graphite powders in size fractions and to recombine the size fractions to obtain a desired particle size distribution. Measures for achieving a target tap density are also well-known in the art and not particularly limited. The tap density (e.g. the tap density after 1500 tamps) will i.a. depend on size and shape factors of the employed graphite and is a parameter that well-catalogued for most commercial graphite materials. Accordingly, selecting a suitable material is not an obstacle for the skilled person.

The present disclosure also relates to an electrode comprising the anode material.

The present disclosure also relates to a battery comprising at least one of the aforementioned electrodes.

The present disclosure further relates to a method of manufacturing the anode material comprising the steps of:
a) providing a carbonaceous graphitizable material and/or a graphitic material and a graphitizable organic binder,
b) providing pitch,
c) mixing of materials of step a) by using a (wt.-) ratio of coke/pitch by 0.05 to 0.8 preferably between 0.15 to 0.7,
d) heating up to 950° C. obtain a carbonized material,
e) heating up to 3100° C. the carbonized material of step e) to obtain a graphitized material,
f) mixing of powder of step g) with an organic graphitizable carbonaceous additive, and
g) heating the mixture of step h) to a temperature of between 800° C. and 1100° C.

The carbonaceous graphitizable material is not particularly limited and can be a coke of a regular or needle type, in particular in such a way that its real density measured by helium is at least 2.05 g/cm³ and 2.18 g/cm³ at most.

The organic graphitizable carbonaceous additive is not particularly limited and can be an organic material which is graphitizable and/or can be carbonized at temperature of between 800° C. and 1100° C. Suitable examples include any kind of petroleum or plant-derived polymer as, for example, pitch, tar, bitumen or asphalt, an epoxy resin, polystyrene, phenolic resin, a polyurethan and a polyvinyl alcohol.

Regarding step f), the organic graphitizable carbonaceous additive is preferably added in amount of between 0.5 and 10 wt.-%, in relation to the powder of step g), more preferably in the range of 3 to 10 wt.-%.

In some embodiments, after step b) can follow step b1) forming a solid body and after step d) can follow step d1) milling.

The present disclosure also relates to the use of the anode for lithium-ion batteries for automotives.

### BRIEF DESCRIPTION OF THE FIGURES

The present disclosure is illustrated with reference to the figures described in the following. The figures are for illustration only and do not limit the scope of the claims.

FIG. 1 is a SEM (scanning electron microscope)-picture showing a standard graphite anode material. It shows a material according to Comparative Example 1.

FIG. 2 is a SEM (scanning electron microscope)-picture showing a graphite anode material according to the present disclosure. It shows a material according to Example 1.

FIG. 3 is a SEM (scanning electron microscope)-picture showing a graphite anode material according to the present disclosure. It shows a material according to Example 2.

FIG. 4 shows the wetting times achieved with the materials of Examples 1 and 2 and Comparative Example 1.

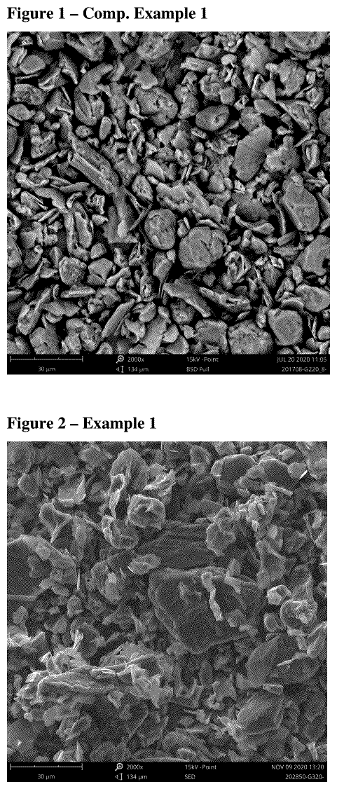

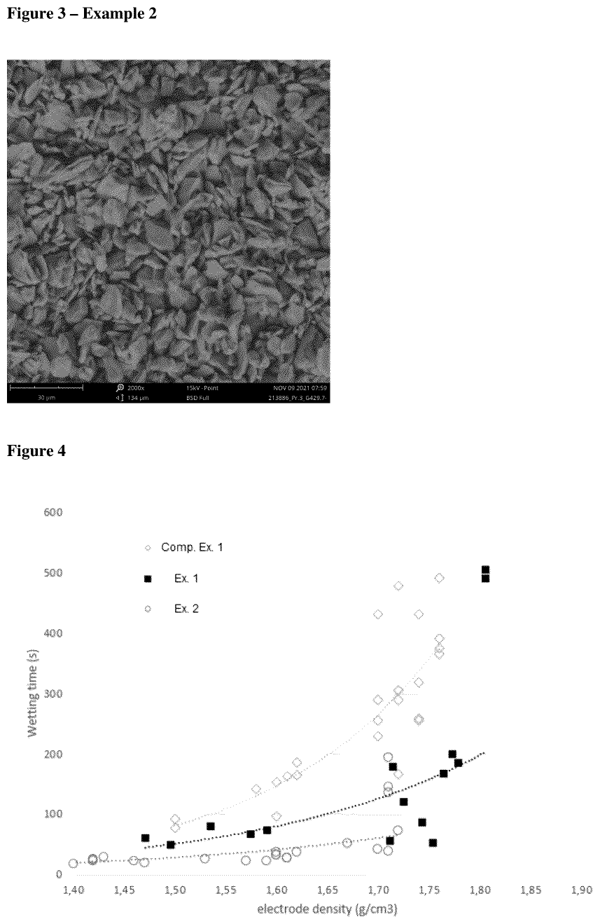

### DETAILED DESCRIPTION

The present disclosure is illustrated with reference to the embodiments described in the following. The embodiments are for illustration only and do not limit the scope of the claims.

### Measurements

The following measuring methods (where appropriate: exemplarily) apply to above description and (again where appropriate) to the examples below.

### Functional Groups

The functional groups were determined by the Böhm Titration method (based on DIN ISO 11352). All the solution used for the determination had a concentration of 0,001 mol/l.

### Determination the Basic Functional Groups:

Few grams, e.g. 5 grams, of the samples were dropped in 200 ml of a diluted solution of HCl for 24 hours. After that, 3×20 ml were taken off and titrated with diluted NaOH.

### Determination of Acidic Functional Groups:

Few grams, e.g. 5 grams, of the samples were dropped in solution of 200 ml of lye (diluted solution of NaOH, Na₂CO₃, NaHCO₃) for 24 hours. After that, 20 or 30 ml of a diluted HCl solution were added. In the end, the solutions were titrated with diluted NaOH.

### Tap Density

The Tap density was measured adapted with a Granupac device by Granutools™. The powder is placed in a metallic tube with a rigorous automated initialization process. Afterwards, a light hollow cylinder is placed on the top of the powder bed to keep the powder/air interface flat during the packing dynamics process.

The tube containing the powder sample rose to a fixed height of AZ and performs free falls. The free fall height is fixed to AZ=1 mm. The height h of the powder bed is measured automatically after each tap.

### D10, D50, D90 and D99-Values

The measurement of the particle size distribution of the anode material is not particularly limited and can be measured using a laser diffraction particle size distribution analyzer, i.e. a device that provides the particle size distribution by a volume standard. Accordingly, the D10-value is the particle size at the point where, starting from the small diameter side of the obtained particle size distribution, the cumulative volume of the particles reaches 10 vol.-%. The D50-, D90- and D99-values are defined likewise.

### Circularity, S50 and S99-Value

The circularity of a particle may be measured by dynamic image analysis on the measuring device QICPIC with the RODOS dry disperser from the company Sympatec, Germany. The measuring method should comply with ISO 13322-2:2021. For a plurality of particles having a plurality of respective circularities, the S50 and S99 values of the obtained distributions of circularities are as defined above.

### Measurement of Wetting Time

### 1. Sample Preparation

Samples for density measurements were obtained by punching out circular disks of coated sheet material.

### 2. Determination of the Density of the Graphite Anode Material Layers

Density of anode material on the circular disk was determined by measuring the thickness of the anode material layer on the circular disk, calculating the volume of the anode material layer from the thickness, weighing the disk, subtracting the mass of the circular metal sheet in order to obtain the mass of the graphite anode material layer and then dividing the mass of the graphite anode material layer by the volume of the graphite anode material layer.

### 3. Determination of Wetting Times

Wetting times were determined by placing a drop of (1M LiPF₆, ethylene carbonate (EC)/ethylmethyl carbonate (EMC) (3/7 vol. ratio), with additives of vinyl carbonate 0.5 wt. %) in the center of an anode material layer of a circular disc and then determining the time until the complete drop was incorporated into the anode material layer.

The drop had a volume of 1 μl and was provided from a syringe with hydrophobized blunt cannula using a dosing device at a flow rate of 1 μl per minute. The syringe arranged vertically. The circular disk was placed on a table. The table with the circular disk was lifted in a controlled way until the drop hanging on the cannula touched the surface of the anode material layer. The table was then quickly moved down a little bit. The time (in seconds [s]) from the instance at which the drop was sitting on the graphite anode material layer until the complete drop was incorporated into the anode material layer is herein considered as the wetting time. The complete drop was considered incorporated into the anode material layer when no more reflections were observed on the surface of the layer.

### Preparation of Calendered Layers of Graphite Anode Material on Metal Sheet

The graphite powder was added to a water-based solution of carboxymethyl cellulose (CMC). To this dispersion styrene-butadiene rubber (SBR) polymers is added as binder. Components are added in the proportion: Graphite/CMC/SBR=98/1/1 wt % to result in the final dispersion (slurry). Electrodes were prepared by coating the slurry onto copper foil using a laboratory coating machine KTF-S 20412 (Werner Mathis AG). After coating the electrode were dried and then compressed by calendering using a laboratory Calender CA 9 (Sumet Systems GmbH) in order to reach the desired final density in the electrode material layer.

### Example 1

A homogeneous green mass is obtained mixing a pitch and coke with ratio of pitch/coke of 0.44. The coke selected is a needle type in such a way that its real density measured by helium is at 2.149 g/cm³.

The green mas was shaped in a solid form and then the obtained blocks were fired at 800-950° C. The baked blocks were then graphitized at a temperature of at least 2750° C. but not higher than 3100° C. After cooling to room temperature, the graphitized material was crushed and ground into a fine powder material to achieve a D₅₀ (50% of between 10 and 20 μm).

The fine pulverized material was mixed by means of a mechanical mixing device with between 0.1 and 10% of solid organic graphitizable carbonaceous additive. The mixture of fine graphitic powder and additive was heated at temperatures between 800° C. and 1100° C. for several hours.

Sum of total functional groups is below detection limit.
Tap density ratio tap1500/tap30: 1.12;
Circularity (S99)=0.95 und (S50)=0.86

### Example 2

A homogeneous green mass is obtained mixing a pitch and coke with a pitch/coke ratio of 0.8. The coke selected is a needle coke in such a way that its real density measured by helium is 2.149 g/cm³. The green mass is fired at 800-950° C. and afterwards graphitized at a temperature of at least 2750° C. but not higher than 3100° C. and then cooled to room temperature.
Tap density ratio tap1500/tap30:1.21;
Circularity (S99)=0.96 und (S50)=0.88

### Comparative Example 1

A homogeneous green mass is obtained mixing a pitch and coke with a pitch/coke ratio 0.42. The coke is selected is a regular coke with real density measured by helium of 2.07. The green mas was shaped in a solid form and then the obtained blocks were fired at 800-950° C. The baked blocks were then graphitized at a temperature of at least 2750° C. but not higher than 3100° C. After cooling to room temperature, the graphitized material was crushed and shaped into a fine powder material to achieve a D50 of between 10 and 20 μm.
Sum of total functional groups is 3.13 μmol/g.
Tap density ratio tap1500/tap30:1.18;
Circularity (S99)=0.95 und (S50)=0.87

As evident from FIG. 4, Examples 1 and 2 outperform Comparative Example 1 in terms of wettability (wetting speed). The formula (I) was derived from a regressional analysis of the data shown in in FIG. 4. Regressional trends are indicated in FIG. 4 by the three full lines. Formula (I) is derived from a regressional analysis of data of Example 1.

1-11. (canceled)

12. An anode material for a lithium ion battery comprising carbon particles, wherein the anode material can be compressed onto a metal sheet to form a dense and fast wetting anode material layer, which anode material layer has a density ρ in g/cm³ and a wetting time tw in seconds which is described by the following formula (I)
$${t}_{w} = {x}_{1} \times ( ρ - 1 , 0 ) + {x}_{2} \times {e}^{( {x}_{3} \times ( ρ - 1 , 7 ) )} \qquad ( I )$$
wherein ρ is the density of the anode material compressed onto a metal sheet and x₁ is between 50 and 158; x₂ is between 3 and 150 x₃ is between 13 and 45.

13. The anode material according to claim 12, wherein the carbon particles comprise graphite.

14. The anode material according to claim 12, wherein sum of total functional groups of the anode material is less or equal to 10 μmol/g.

15. The anode material according to claim 12, wherein the anode material has a distribution with 50% of the volume of the distribution with a circularity (s₅₀) of 0.85-1.0.

16. The anode material according to claim 12, wherein the anode has a distribution with 99% of the volume of distribution with a circularity (s₉₉) of 0.95 to 1.

17. The anode material according to claim 12, wherein the anode material has a ratio of tap density of tap 1500/tap 30 of 1.0-2.2.

18. An electrode comprising an anode material according to claim 12.

19. A battery comprising at least one electrode according to claim 18.

20. A method of manufacturing the anode material according to claim 12, comprising the steps of:
a) providing a carbonaceous graphitizable material and or a graphitic material and a graphizable organic binder
b) mixing of materials of step a) by using a ratio of coke/pitch by 0.05 to 0.8.
c) heating up to 950° C. obtain a carbonizes material
d) heating up to 3100° C. the carbonized material of step c) to obtain a graphitized material
e) mixing of powder of step d) with an organic graphitizable carbonaceous additive
f) heating the mixture of step e) to a temperature of between 800° C. and 1100° C.

21. The method of manufacturing the anode material according to claim 20, wherein after step b) follows step b1) forming a solid body and after step d) follows step d1) milling.
